(19) United States
(12) Patent Application Publication
(10) Pub. No.: US 2025/0053773 A1
(43) Pub. Date: Feb. 13, 2025

(54) INTELLIGENT SELF-GROWING AVATAR

(71) Applicant: International Business Machines Corporation, Armonk, NY (US)

(72) Inventors: Su Liu, Austin, TX (US); Yu Zhu, Beijing (CN); Peng Hui Jiang, Beijing (CN); Jun Su, Beijing (CN); Guang Han Sui, Beijing (CN); Jun Feng Duan, Beijing (CN)

(21) Appl. No.: 18/448,288

(22) Filed: Aug. 11, 2023

(51) Int. Cl. G06N 3/006

(52) U.S. Cl. CPC G06N 3/006

(57) ABSTRACT

A method for maintaining an intelligent self-growing avatar (ISGA) in a metaverse is presented including supporting the ISGA with an ISGA server communicating with an ISGA client, collecting, via an ISGA data structure, personal characteristics and activities of a person in a real world, creating, via an avatar creator, an avatar having the personal characteristics of the person in the real world, training, via an ISGA trainer, the avatar to recognize and respond to the activities and relationships of the real person, and changing, via an ISGA adjuster, a behavior and personality of the avatar based on the activities and relationships of the real person in the real world to allow the avatar to continuously grow and evolve in the metaverse.

### BACKGROUND

The present invention relates generally to the metaverse, and more specifically, to an intelligent self-growing avatar enabled with real-time personal characteristic learning services.

The metaverse is an emerging 3D-enabled digital space that uses virtual reality, augmented reality, and other advanced internet and semiconductor technology to allow people to have lifelike personal and business experiences online. The metaverse is a virtual immersive environment or virtual world. The metaverse spans the virtual and the physical worlds. In the metaverse, an individual can select a persona, also referred to as an avatar, who represents the individual. This avatar provides a transition of the individual from the real world to the metaverse.

### SUMMARY

In accordance with an embodiment, a method for maintaining an intelligent self-growing avatar (ISGA) in a metaverse is provided. The method includes supporting the ISGA with an ISGA server communicating with an ISGA client, collecting, via an ISGA data structure, personal characteristics and activities of a person in a real world, creating, via an avatar creator, an avatar having the personal characteristics of the person in the real world, training, via an ISGA trainer, the avatar to recognize and respond to the activities and relationships of the real person, and changing, via an ISGA adjuster, a behavior and personality of the avatar based on the activities and relationships of the real person in the real world to allow the avatar to continuously grow and evolve in the metaverse.

In accordance with another embodiment, a computer program product is provided for maintaining an intelligent self-growing avatar (ISGA) in a metaverse, the computer program product comprising a computer readable storage medium having program instructions embodied therewith. The program instructions are executable by a computer to cause the computer to support the ISGA with an ISGA server communicating with an ISGA client, collect, via an ISGA data structure, personal characteristics and activities of a person in a real world, create, via an avatar creator, an avatar having the personal characteristics of the person in the real world, train, via an ISGA trainer, the avatar to recognize and respond to the activities and relationships of the real person, and change, via an ISGA adjuster, a behavior and personality of the avatar based on the activities and relationships of the real person in the real world to allow the avatar to continuously grow and evolve in the metaverse.

In accordance with yet another embodiment, a system for maintaining an intelligent self-growing avatar (ISGA) in a metaverse is provided. The system includes a memory and one or more processors in communication with the memory configured to support the ISGA with an ISGA server communicating with an ISGA client, collect, via an ISGA data structure, personal characteristics and activities of a person in a real world, create, via an avatar creator, an avatar having the personal characteristics of the person in the real world, train, via an ISGA trainer, the avatar to recognize and respond to the activities and relationships of the real person, and change, via an ISGA adjuster, a behavior and personality of the avatar based on the activities and relationships of the real person in the real world to allow the avatar to continuously grow and evolve in the metaverse.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1 is a block/flow diagram of an exemplary intelligent self-growing avatar (ISGA) system, in accordance with an embodiment of the present invention;

FIG. 2 is a block/flow diagram of an exemplary method for implementing the ISGA, in accordance with an embodiment of the present invention;

FIG. 3 is a block/flow diagram of an exemplary flow chart for establishing an artificial intelligence (AI) driven ISGA, in accordance with an embodiment of the present invention;

FIG. 4 is a block/flow diagram of an exemplary flow chart for training the ISGA, in accordance with an embodiment of the present invention;

FIG. 5 is a block/flow diagram of an exemplary flow chart for enabling the avatar to grow in real-time, in accordance with an embodiment of the present invention;

FIG. 6 is a block/flow diagram of an exemplary practical application employing the ISGA system of FIG. 1, in accordance with an embodiment of the present invention; and

FIG. 7 is a block diagram of an exemplary computer system for applying the ISGA system of FIG. 1, in accordance with an embodiment of the present invention.

Throughout the drawings, same or similar reference numerals represent the same or similar elements.

### DETAILED DESCRIPTION

Embodiments in accordance with the present invention provide methods and systems for generating an avatar with the personal characteristics of a real person in the real world. The avatar can learn the activities and relationships of the real person and continue to evolve in the metaverse over time. The exemplary embodiments provide a way for users to create or generate avatars that fully capture their personal characteristics in the real world.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

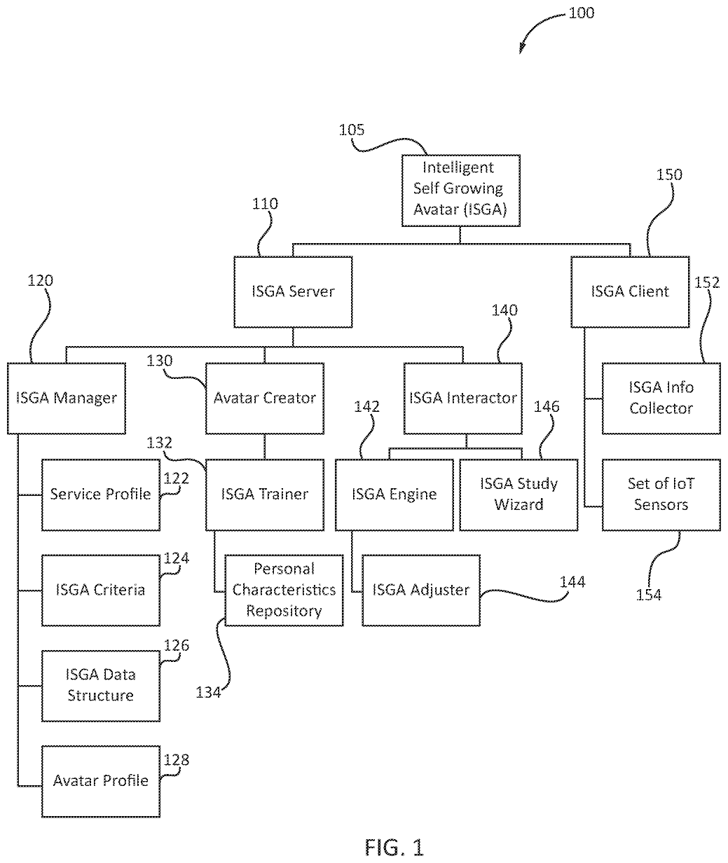

FIG. 1 is a block/flow diagram of an exemplary intelligent self-growing avatar (ISGA) system, in accordance with an embodiment of the present invention.

The intelligent self-growing avatar (ISGA) system or architecture 100 includes an intelligent self-growing avatar (ISGA) 105. The framework of the ISGA 105 includes an ISGA server 110 and an ISGA client 150.

The ISGA server 110 communicates with an ISGA manager 120, an avatar creator 130, and an ISGA interactor 140.

The ISGA manager 120 includes a service profile 122, ISGA criteria 124, ISGA data structure 126, and an avatar profile 128.

The avatar creator 130 includes an ISGA trainer 132 and a personal characteristics repository 134.

The ISGA interactor 140 includes an ISGA engine 142 and an ISGA study wizard 146. The ISGA engine 142 has an ISGA adjuster 144.

The ISGA client 150 includes an ISGA information collector 152 and a set of Internet of Things (IoT) sensors 154.

The exemplary embodiments establish an artificial intelligence (AI) driven intelligent self-growing avatar in the metaverse. The ISGA automatically collects user related information from both the real world and the virtual world, when the user is offline. The information may include but is not limited to creating a knowledge database for the avatar to make sure the avatar has up-to-date information, operating the avatar to live in the metaverse and interact with other avatars, automatically identify the target avatar and topics, automatically leverage a user's avatar knowledge database to provide the proper action and interaction, automatically change the avatar's appearance and skill based on the knowledge base (under the user's authentication), and creating an updated digest and presenting it to the user visually when user comes back online.

In other embodiments, the user related information includes user personal data in the real world, e.g., user profile data, physical data, and/or behavior data. The user related information further includes user/avatar activities and skills in both the real world and the virtual world. The user related information further includes a user's social interaction data, e.g., relationship, social network activity record, and/or updates from friends. Moreover, the user's avatar knowledge database is leveraged to include using machine learning techniques to recognize and respond to the activities and relationships of the real person.

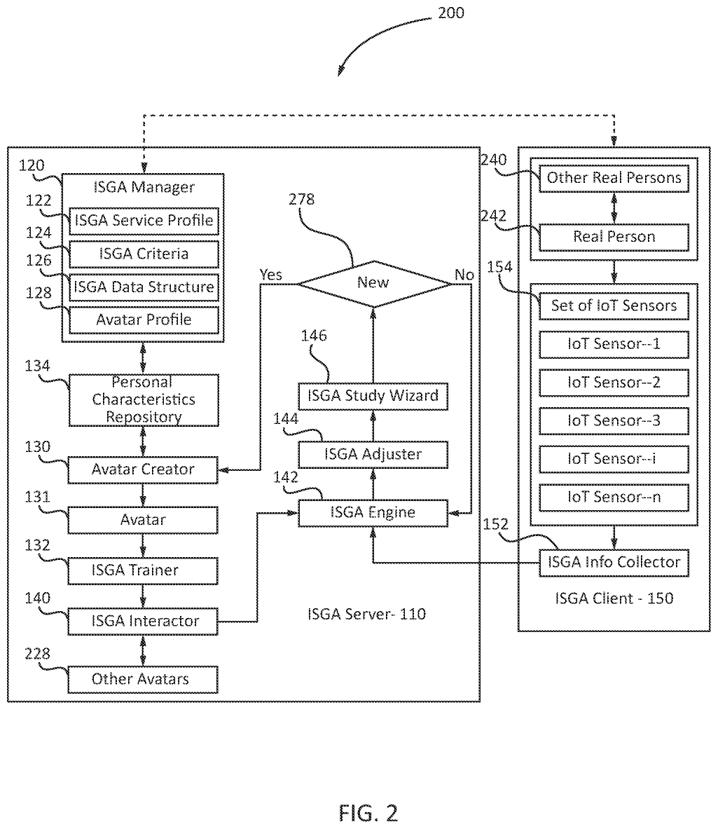

FIG. 2 is a block/flow diagram of an exemplary method 200 for implementing the ISGA, in accordance with an embodiment of the present invention.

The ISGA server 110 communicates with the ISGA client 150. The ISGA information collector 152 collects data or information from the set of IoT sensors 250 pertaining to a real person 240 and other real persons 242. The data collected by the ISGA information collector 152 is provided to the ISGA engine 142 that evaluates and analyzes the data via the ISGA adjuster 144. The adjusted data is provided to the ISGA study wizard 146 which learns to categorize the new information.

At block 278, it is determined whether new data has been collected. If NO, the process proceeds back to the ISGA engine 142. If YES, the new data is forwarded to the avatar creator 222.

The avatar creator 222 employs the ISGA trainer 132 to train the avatar to recognize and respond to the activities and relationships of the real person derived from the ISGA interactor 140. Information from other avatars 228 can also be incorporated. The avatar creator 222 also communicates with the personal characteristics repository 134, which is in direct communication with the ISGA manager 120.

Therefore, the exemplary embodiments define a method of ISGA-enabled with a real-time personal characteristic learning services for supporting an avatar to maintain and expand his/her virtual social network and grow in the metaverse over time. The exemplary method includes defining a framework or architecture 100 to support the ISGA 105 by employing an ISGA server 110, service profile 122, ISGA criteria 124, ISGA information collector 152, and personal characteristics repository 134. The exemplary method further includes defining a data structure 126 for tracking and saving the personal characteristics and activities of the real person in the real world.

ISGA data can include, e.g., RealPersonID, PersonalCharacteristics, AavatarID, RealSocialNetwork (Friend-1, Friend-2, . . . ), VirsualSocialNetwork (Aavatar-1, Aavatar-2, . . . ), UpdatedInfo, Event[time][location]), etc. This data would be part of the ISGA data structure 126. The exemplary method further includes creating an avatar 131 with all the personal characteristics of a real person in the real world, where the personal characteristics include, e.g., physical appearance, voice, personality traits, and behavior. This is accomplished through the avatar creator 130.

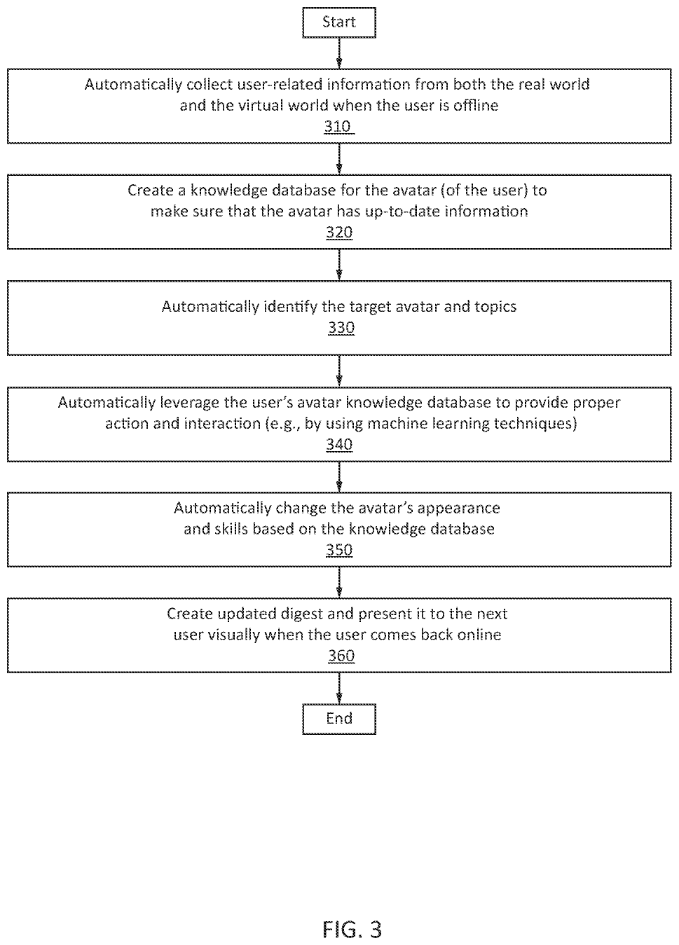

FIG. 3 is a block/flow diagram of an exemplary flow chart for establishing an artificial intelligence (AI) driven ISGA, in accordance with an embodiment of the present invention.

At block 310, automatically collect user-related information from both the real world and the virtual world when the user is offline.

At block 320, create a knowledge database for the avatar (of the user) to make sure that the avatar has up-to-date information.

At block 330, automatically identify the target avatar and topics.

At block 340, automatically leverage the user's avatar knowledge database to provide proper action and interaction (e.g., by using machine learning techniques).

At block 350, automatically change the avatar's appearance and skills based on the knowledge database.

At block 360, create updated digest and present it to the user visually when the user comes back online.

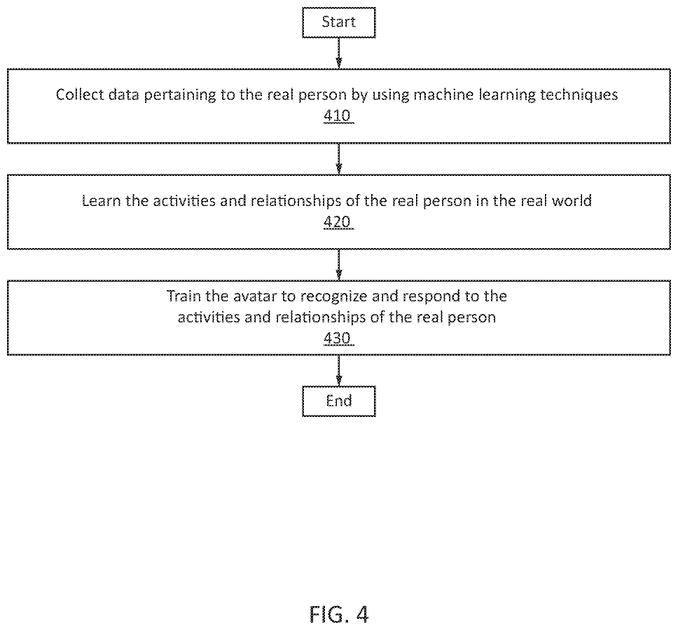

FIG. 4 is a block/flow diagram of an exemplary flow chart for training the ISGA, in accordance with an embodiment of the present invention.

At block 410, collect data pertaining to the real person by using machine learning techniques.

At block 420, learn the activities and relationships of the real person in the real world.

At block 430, train the avatar to recognize and respond to the activities and relationships of the real person.

Therefore, the training involves collecting data pertaining to the real person using, e.g., machine learning techniques. The data may be gathered from social media accounts, voice/video recordings, and other digital sources via the ISGA information collector 152 and the set of IoT sensors 154. The training further includes learning the activities and relationships of the real person in the real world via the ISGA learner. Training the avatar to recognize and respond to the activities and relationships of the real person is thus accomplished by employing the ISGA trainer 132.

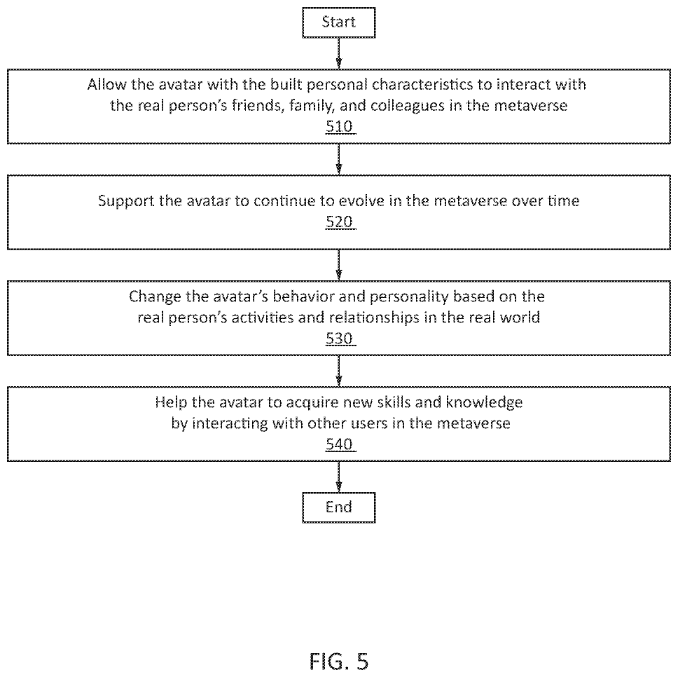

FIG. 5 is a block/flow diagram of an exemplary flow chart for enabling the avatar to grow in real-time, in accordance with an embodiment of the present invention.

At block 510, allow the avatar with the built personal characteristics to interact with the real persons friends, family, and colleagues in the metaverse. In various embodiments, friends, family, and colleagues of the real person are identified from a predetermined list or grouping.

At block 520, support the avatar to continue to evolve in the metaverse over time.

At block 530, change the avatar's behavior and personality based on the real person's activities and relationships in the real world.

At block 540, help the avatar to acquire new skills and knowledge by interacting with other users in the metaverse.

The flowchart of FIG. 5 allows the avatar with the built personal characteristic to interact with the real person's friends, family, and colleagues in the metaverse via the ISGA interactor 140. The avatar is supported to continue to evolve in the metaverse over time via the ISGA engine 142. Changing the avatar's behavior and personality based on the real person's activities and relationships in the real world is enabled by the ISGA adjuster 144. Helping the avatar to acquire new skills and knowledge by interacting with other users in the metaverse is enabled by the ISGA study wizard 146. Therefore, avatar-to-avatar interactions can enable an avatar to change, grow and evolve.

In other embodiments, the system uses machine learning techniques to create an avatar with all the personal characteristics of a real person in the real world. The avatar can learn the activities and relationships of the real person by analyzing data from social media accounts, voice recordings, and other digital sources. The avatar can interact with the real person's friends, family, and colleagues in the metaverse, as well as with other new people. These continued interactions with other avatars can affect the behaviors and personality of the avatar.

In further embodiments, the avatar can continue to evolve in the metaverse over time. The avatar's behavior and personality can change based on the real person's activities and relationships in the real world. The avatar can also acquire new skills and knowledge by interacting with other users in the metaverse. Thus, the avatar does not remain stagnant or passive or static but evolves with new skills and traits due to continued interactions. The avatar can be referred to as a dynamic avatar or ever-changing avatar or developing avatar.

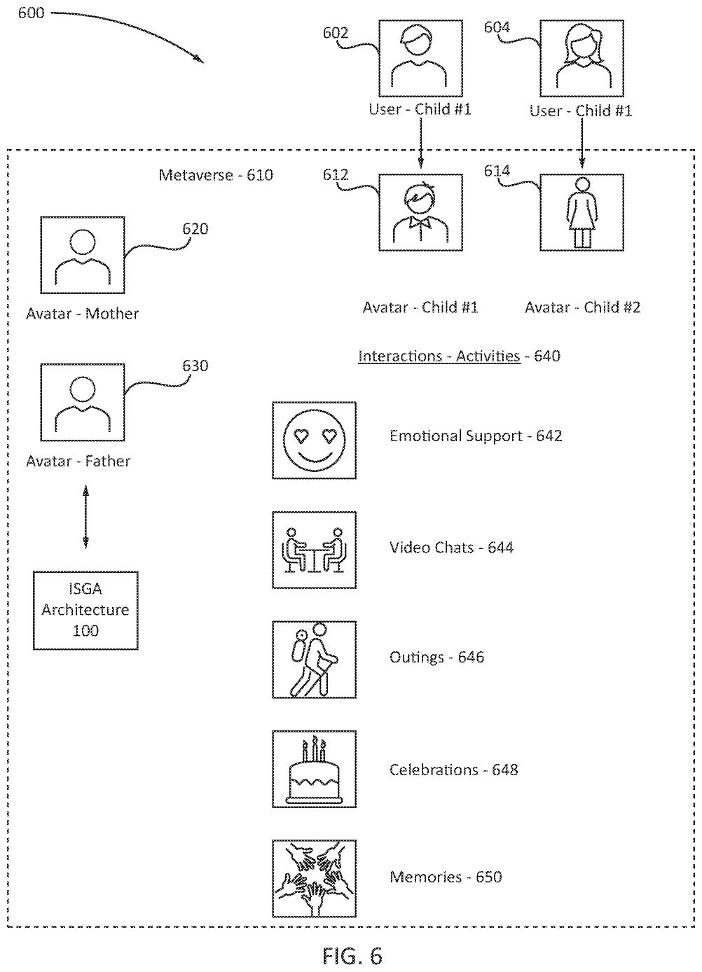

FIG. 6 is a block/flow diagram of an exemplary practical application 600 employing the ISGA system of FIG. 1, in accordance with an embodiment of the present invention.

In the practical application 600, a first user 602 and a second user 604 interact with the metaverse 610. The first user 602 can create a first avatar 612 and the second user 604 can create a second avatar 614. The first and second users 602, 604 wish to interact with their mother's avatar 620 and their father's avatar 630. In the instant case, both the father and the mother have passed away. However, the mother's and the father's avatars 620, 630 are alive and well in the metaverse 610. The avatars 620, 630 can communicate with the ISGA architecture 100. Therefore, the parent avatars were created in the metaverse 610 enabling the living children (users 612, 614) to continue interacting with their deceased parents. The children 612, 614 can engage in different activities 640 with their parents.

Such activities 640 can include, e.g.:

Emotional support 642, that is, parent avatars 620, 630 in the metaverse 610 could provide emotional support to the children 612, 614 and family members. For example, parent avatars 620, 630 could listen the children's problems, offer advice, or simply be a comforting presence. This could help the children 612, 614 cope with the loss of their parents and feel less alone in their grief.

Video chats 644, that is, just like in real life, a person could have video chats with the parent avatars 620, 630 in the metaverse 610. The children 612, 614 could see and hear the parents, and the children could see and hear the parents. This would allow the children 612, 614 to have conversations with the parents and catch up on each other's lives.

Virtual outings 646, that is, the children 612, 614 could go on virtual outings with the parent avatars 620, 630 in the metaverse 610. For example, the children 612, 614 could take them to a virtual museum, go on a virtual hike, or attend a virtual concert together. This would allow the children to share experiences with the parents, even if they are no longer physically present in the real world.

Virtual celebrations, 648, that is, the children could celebrate special occasions with the parent avatars 620, 630 in the metaverse 610. For example, the children could have a virtual birthday party for the parents, or celebrate holidays together. This would allow the children 612, 614 to include the parents in important moments of their life.

Memory sharing 650, that is, the children could share memories with the parent avatars 620, 630 in the metaverse 610. For example, the children could show the parents pictures and videos of important moments in their lives, or tell the parents stories about their experiences. This would allow the children to keep their memory alive and continue to feel connected to the parents.

The parent avatars 620, 630 would absorb all this new information from the children and grow or evolve as a result of such new information. Thus, in the next interaction, the parent avatars 620, 630 would already know the previous new information provided to them and would have further conversations with the children (with the past information already absorbed or consumed or taken into account).

For example, if one child informed their parents that they passed a math exam and a chemistry exam in college and graduated from college (in May 2023), the parent avatars 620, 630 would be able to have a conversation pertaining to job opportunities (in August 2023), as the parent avatars 620, 630 already know that the child graduated from college (and passed certain exams). All this information can be stored in various customized knowledge databases.

Of course, one skilled in the art can contemplate many different scenarios where living people create avatars to continually communicate with friends or relatives that have passed away. As a result, the exemplary embodiments allow an avatar to fully capture the personal characteristics of a real person in the real world and continuously grow or change or evolve in the metaverse. The avatar can continue to exist and automatically grow in the metaverse when the user does not take control of the avatar, that is, the user is offline or absent or sick or on a long trip or has even passed away. Thus, the avatar is a digital representation of the person's identity and can continue to exist and interact with others in the metaverse, and evolve in the metaverse over time.

In an alternative embodiment, the avatar updates are performed continuously in real-time. In another exemplary embodiment, the avatar updates are performed periodically, e.g., once a day, once a week, etc. In another embodiment, the real person can designate when his/her avatar is updated. In yet another embodiment, the real person can have the option to select which behaviors and/or personality traits are continuously updated in the metaverse. For example, the real person may not want negative behaviors or negative personality traits to be reflected in his/her avatar in the metaverse. Therefore, the real person can have control over which personality traits and/or behaviors are updated for his or her avatar in the metaverse.

In an alternative embodiment, the real person has the option to approve or disapprove or revise any updates made to the avatar in the metaverse. In another embodiment, different knowledge databases can be created or generated. One knowledge database can include features that the real person wishes to share, whereas another knowledge database can include features that the real person does not wish to share (at least not at this time). As a result, a plurality of knowledge databases can be created that are controlled by the real person. Each knowledge database can include different behaviors or different characteristics of the real person, and it can be revised or edited by the real person at any time. Such knowledge databases can be shared at different time periods or time frames.

For example, a cousin of the children may share various events or preparations with the children. However, for one reason or another, the children may not want the parents to know about the information shared between the cousin and the children. Maybe it is a surprise party for the parents. As such, the children can control their avatars to not be updated or adjusted just yet with their interaction with the cousin, lest the parents of the children inquire about the conversation the children had with the cousin.

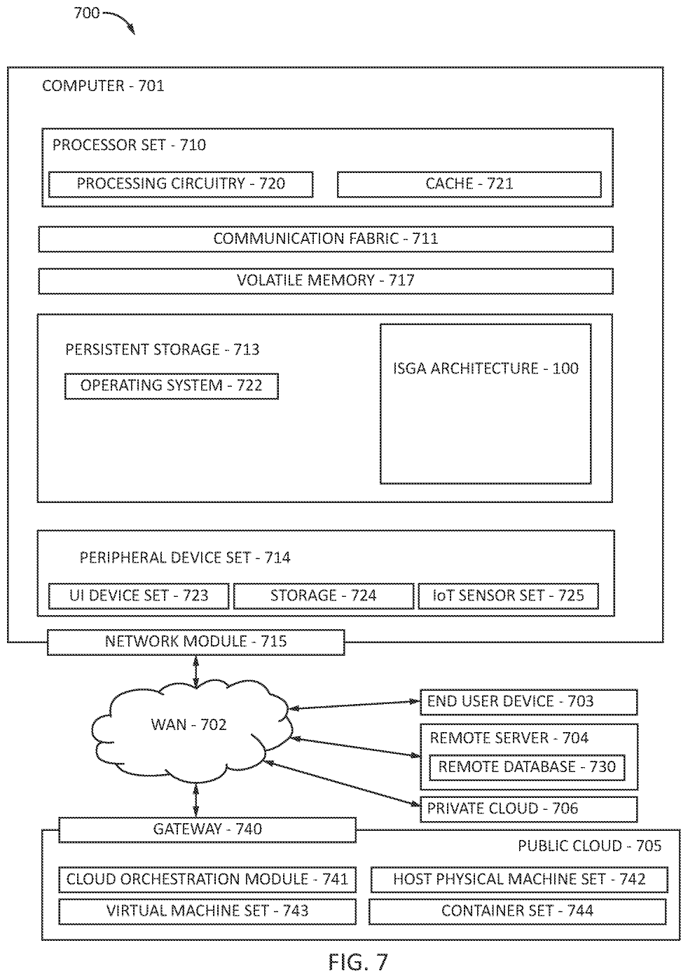

FIG. 7 is a block diagram of an exemplary computer system for applying the ISGA system of FIG. 1, in accordance with an embodiment of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is usually moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the inventive methods, such as the audio and ISGA 100. In addition to block 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 6. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 750 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It is also noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments for maintaining an intelligent self-growing avatar (ISGA) in a metaverse (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for maintaining an intelligent self-growing avatar (ISGA) in a metaverse, the method comprising:
supporting the ISGA with an ISGA server communicating with an ISGA client;
collecting, via an ISGA data structure, personal characteristics and activities of a person in a real world;
creating, via an avatar creator, an avatar having the personal characteristics of the person in the real world;
training, via an ISGA trainer, the avatar to recognize and respond to the activities and relationships of the real person; and
changing, via an ISGA adjuster, a behavior and personality of the avatar based on the activities and relationships of the real person in the real world to allow the avatar to continuously grow and evolve in the metaverse.

2. The method of claim 1, wherein the personal characteristics and activities of the person in the real world are collected by machine learning techniques from social media accounts, voice recordings, video recordings, and other digital sources.

3. The method of claim 1, wherein the avatar continuously acquires new skills and knowledge by interacting with other avatars in the metaverse by using an ISGA study wizard.

4. The method of claim 1, wherein the avatar interacts with a friend, family, and colleague of the real person in the metaverse via an ISGA interactor.

5. The method of claim 1, wherein the ISGA data structure is part of an ISGA manager that further includes and ISGA service profile and ISGA criteria.

6. The method of claim 1, wherein the avatar grows and evolves in the metaverse regardless of whether the real person is alive or deceased.

7. The method of claim 1, wherein a knowledge database is used for storing the changing behavior and personality of the avatar.

8. A computer program comprising a computer readable storage medium having program instructions embodied therewith for maintaining an intelligent self-growing avatar (ISGA) in a metaverse, the program instructions executable by a computer to cause the computer to:
support the ISGA with an ISGA server communicating with an ISGA client;
collect, via an ISGA data structure, personal characteristics and activities of a person in a real world;
create, via an avatar creator, an avatar having the personal characteristics of the person in the real world;
train, via an ISGA trainer, the avatar to recognize and respond to the activities and relationships of the real person; and
change, via an ISGA adjuster, a behavior and personality of the avatar based on the activities and relationships of the real person in the real world to allow the avatar to continuously grow and evolve in the metaverse.

9. The computer program product of claim 8, wherein the personal characteristics and activities of the person in the real world are collected by machine learning techniques from social media accounts, voice recordings, video recordings, and other digital sources.

10. The computer program product of claim 8, wherein the avatar continuously acquires new skills and knowledge by interacting with other avatars in the metaverse by using an ISGA study wizard.

11. The computer program product of claim 8, wherein the avatar interacts with a friend, family, and colleague of the real person in the metaverse via an ISGA interactor.

12. The computer program product of claim 8, wherein the ISGA data structure is part of an ISGA manager that further includes and ISGA service profile and ISGA criteria.

13. The computer program product of claim 8, wherein the avatar grows and evolves in the metaverse regardless of whether the real person is alive or deceased.

14. The computer program product of claim 8, wherein a knowledge database is used for storing the changing behavior and personality of the avatar.

15. A system for maintaining an intelligent self-growing avatar (ISGA) in a metaverse, the system comprising:
a memory; and
one or more processors in communication with the memory configured to:
support the ISGA with an ISGA server communicating with an ISGA client;
collect, via an ISGA data structure, personal characteristics and activities of a person in a real world;
create, via an avatar creator, an avatar having the personal characteristics of the person in the real world;
train, via an ISGA trainer, the avatar to recognize and respond to the activities and relationships of the real person; and
change, via an ISGA adjuster, a behavior and personality of the avatar based on the activities and relationships of the real person in the real world to allow the avatar to continuously grow and evolve in the metaverse.

16. The system of claim 15, wherein the personal characteristics and activities of the person in the real world are collected by machine learning techniques from social media accounts, voice recordings, video recordings, and other digital sources.

17. The system of claim 15, wherein the avatar continuously acquires new skills and knowledge by interacting with other avatars in the metaverse by using an ISGA study wizard.

18. The system of claim 15, wherein the avatar interacts with a friend, family, and colleague of the real person in the metaverse via an ISGA interactor.

19. The system of claim 15, wherein the ISGA data structure is part of an ISGA manager that further includes and ISGA service profile and ISGA criteria.

20. The system of claim 15, wherein the avatar grows and evolves in the metaverse regardless of whether the real person is alive or deceased.
